(19) United States
(12) Patent Application Publication
(10) Pub. No.: US 2007/0057758 A1
(43) Pub. Date: Mar. 15, 2007

(54) INDUCTOR

(75) Inventor: Kan Sano, Tokyo (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Sumida Corporation

(21) Appl. No.: 11/531,071

(22) Filed: Sep. 12, 2006

(30) Foreign Application Priority Data
Sep. 12, 2005 (JP) 2005-263503

(51) Int. Cl. H01F 27/24

(52) U.S. Cl. 336/212

(57) ABSTRACT

In an inductor of the type including a winding and a drum-type core around which the winding is wound and being mounted on a substrate, terminal members having electrical conductivity are arranged on an outer peripheral portion of the drum-type core and ends of the winding are connected to positions higher than a lower end surface of the drum-type core in the terminal members.

### CLAIM OF PRIORITY

This application claims the benefit of Japanese Patent Application No. 2005-263503 filed on Sep. 12, 2005, the entire contents of which are hereby incorporated by reference herein.

### BACKGROUND OF THE INVENTION

1. Field of the Invention

The present invention relates to an inductor used for various kinds of electronic devices such as mobile phone, personal computer, and television.

2. Description of the Related Art

In recent years, there has been a demand for reducing size and thickness of various kinds of electronic devices such as mobile phone and personal computer. Along with this demand, there has been also a demand for reducing size and thickness of an inductor of a surface mounting type mounted on an electronic circuit board used for the above-mentioned electronic device.

Moreover, conventionally, construction in which a terminal is fixed to the bottom surface to be mounted of an inductor by an adhesive or the like and a winding is connected to the terminal has been generally employed as the inductor of the surface mounting type. One of inductors like this is disclosed in Japanese Patent Application Laid-Open No. 10-22137.

In the inductor disclosed in Japanese Patent Application Laid-Open No. 10-22137, a terminal connected to the winding is directly fixed to the bottom surface of lower collar portion of a drum-type core by an adhesive and hence the size of the inductor is enlarged in the direction of height by the thickness of the terminal. This presents a problem that the inductor is increased in height.

### SUMMARY OF THE INVENTION

The present invention has been made under the above-mentioned circumstances. The object of the present invention is to provide an inductor having a small size in the direction of height.

In order to solve the above-mentioned problem, the present invention is an inductor of the type having a winding and a core around which the winding is wound and being mounted on a substrate, wherein a terminal member having electrical conductivity is arranged on an outer peripheral portion of the core, and wherein an end of the winding is connected to a position higher than a bottom surface of the core in the terminal member.

In the case of this construction, the terminal member having electrical conductivity is arranged on the outer peripheral portion of the core and the end of the winding is connected to a position higher than a bottom surface of the core in the terminal member. Thus, as compared with a case where the terminal member is arranged on the bottom surface of the core, the inductor can be reduced in height by the thickness of the terminal member. Moreover, the terminal member has electrical conductivity and the end of the winding is connected to the terminal member. Hence, the winding can be electrically conductive to the substrate in a state where the inductor is surface-mounted on the substrate.

In addition to the above-mentioned invention according to another invention, the terminal member is a metal member having extending portions extending in the same direction from its both ends and formed in the shape of a letter C. In the case of this construction, the terminal member can be easily fixed to the core by the existence of the extending portions. Moreover, since the terminal member is a metal member, the terminal member has electrical conductivity. For this reason, the winding can be electrically conductive to the substrate reliably in a state where the inductor is surface-mounted on the substrate.

Moreover, still another invention is the inductor in the above-mentioned invention wherein the terminal member has a recess formed on an outer peripheral surface formed in the shape of a letter C. Hence, the end of the winding can be arranged in the recess so as to be fitted therein.

Further, in addition to the above-mentioned each invention according to still another invention, an upper end of the terminal member is located below an upper end surface of the core and a lower end of the terminal member is located at the same plane of the lower end surface of the core or so as to slightly protrude downward from the lower end surface. In the case of this construction, the terminal member does not protrude upward from the upper end surface of the core. Hence, this can prevent the inductor from being increased in height by the thickness of the terminal member. Moreover, the lower end of the terminal member is located at the same plane of the lower end surface of the core or so as to slightly protrude downward from the lower end surface. Hence, the terminal member is put into reliable contact with the surface of the substrate. Therefore, the inductor can be mounted on the substrate so as to be electrically conductive to the substrate reliably.

Furthermore, still another invention is the inductor in the above-mentioned each invention, wherein the terminal member is bonded and fixed to outer peripheral edges of flange parts formed on both ends of the core.

Furthermore, still another invention is the inductor in the above-mentioned invention, wherein the outer peripheral edge of the flange part is formed in the shape of a circular arc, and wherein the surface of the terminal member bonded to the outer peripheral edge is formed in the shape of a circular arc so as to overlap the shape of a circular arc of the outer peripheral edge. For this reason, bonding area can be increased and bonding strength can be increased.

Furthermore, still another invention is the inductor in the above-mentioned each invention, wherein the core is a nickel-based ferrite core.

### EFFECT OF THE INVENTION

According to the present invention, the inductor can be reduced in height.

### BRIEF DESCRIPTION OF THE DRAWINGS

FIG. 1 is a perspective view showing a configuration of an inductor according to one embodiment of the present invention;

FIG. 2 is a side view of the inductor when viewed from a direction shown by arrow A in FIG. 1;

FIG. 3 is a plan view showing a configuration of the inductor in FIG. 1;

FIG. 4 is a side view of the inductor when viewed from a direction shown by arrow B in FIG. 1;

FIG. 5 is a partial cross-sectional view of a state where an inductor is mounted on a substrate and is an enlarged view showing a portion shown by X in FIG. 2;

FIG. 6 is a diagram showing a modification of the present invention and is a plan view of an inductor when a terminal member is bent in the shape of a circular arc; and

FIG. 7 is a diagram showing another modification of the present invention and is a plan view of an inductor when a leading groove is formed in an upper flange part.

### DESCRIPTION OF THE PREFERRED EMBODIMENTS

Hereinafter, an inductor 10 according to one embodiment of the present invention will be described with reference to the drawings.

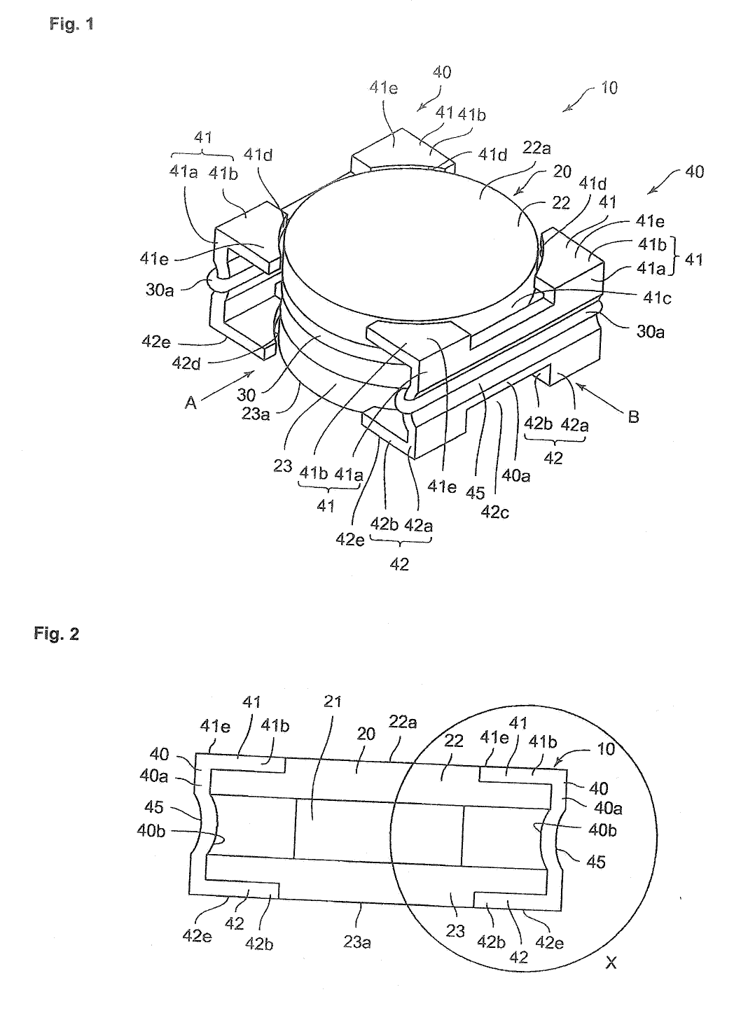

FIG. 1 is a perspective view showing a configuration of an inductor 10 according to one embodiment of the present invention. FIG. 2 is a side view of the inductor 10 when viewed from a direction shown by arrow A in FIG. 1. In the following description, an upper side (upper end side) indicates a side where an upper flange part 22 to be later described exists and a lower side (lower end side) indicates a side where a lower flange part 23 to be later described exists. Moreover, although the depiction of a winding 30 will not be described in FIG. 2, it is assumed that the winding 30 exists.

The inductor 10 is an inductor of a surface mounting type and is mainly consisted of a drum-type core 20, the winding 30 wound around the drum-type core 20, and two terminal members 40 arranged on the outer peripheral portion of the drum-type core 20 so as to be opposite to each other.

The drum-type core 20 is consisted of a magnetic material such as nickel-based ferrite. As shown in FIG. 1 and FIG. 2, the drum-type core 20 includes a winding shaft 21 formed in the shape of a cylinder, an upper flange part (one of the flange parts) 22 and a lower flange part (one of the flange parts) 23 which are formed on both ends in the up and down direction of the winding shaft 21 and each of which is formed in the shape of a circular disk having a larger diameter than the winding shaft 21. The outside diameter of the upper flange part 22 is equal to that of the lower flange part 23. However, the outside diameter of the upper flange part 22 may be different from that of the lower flange part 23.

The winding 30 which is made of copper and has its outside covered with a film is wound around the outer periphery of the winding shaft 21. However, the material of the winding 30 is not limited to copper but may be other metal having good electrical conductivity.

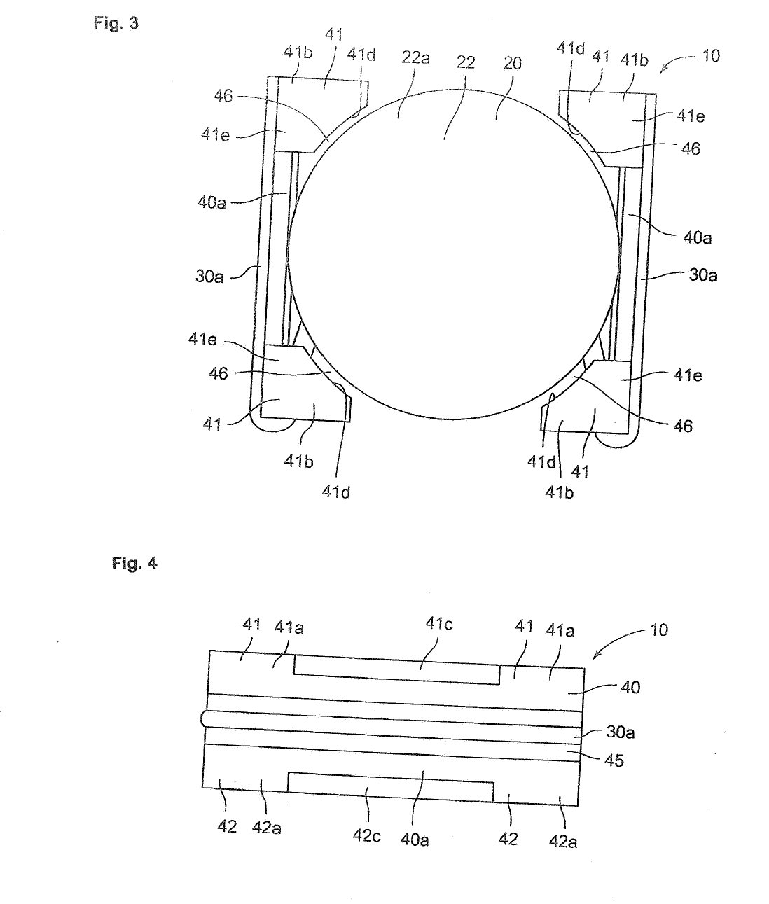

FIG. 3 is a plan view showing the configuration of the inductor 10. FIG. 4 is a side view of the inductor 10 when viewed from a direction shown by arrow B in FIG. 1.

As shown in FIG. 1 to FIG. 3, two terminal members 40 are arranged on the outer peripheral portion of the drum core 20 so as to be opposite to each other. Each of the terminal members 40 has a flat plate portion 40a formed in a nearly rectangular shape and has an upper extending portion 41 and a lower extending portion 42 which extend in a direction perpendicular to the flat plate portion 40a from an upper side and a lower side at both end portions in the longitudinal direction of the flat plate portion 40a, respectively. The terminal member 40 is member made of copper-based metal having a small resistance. The upper extending portion 41, as shown in FIG. 1, has upward extending portions 41a which extend upward from the flat plate portion 40a and perpendicular extending portions 41b which extend from the tips of the respective upward extending portions 41a in a direction perpendicular to the flat plate portion 40a. Similarly, the lower extending portion 42, as shown in FIG. 1, has downward extending portions 42a which extend downward from the flat plate portion 40a and perpendicular extending portions 42a which extend from the tips of the respective downward extending portions 42a in a direction perpendicular to the flat plate portion 40a. Moreover, as shown in FIG. 1, the perpendicular extending portions 41b, 42a extend in the same direction with respect to the flat plate portion 40a (in a direction toward the drum-type core 20). As shown in FIG. 4, an upward groove portion 41c is formed between the upward extending portions 41a and a downward groove portion 42c is formed between the downward extending portions 42a

As shown in FIG. 1 or FIG. 3, a cut portion 41d cut along the outside diameter of the upper flange part 22 is formed inside each of the perpendicular extending portions 41b and a cut portion 42d cut along the outside diameter of the lower flange part 23 is formed inside each of the perpendicular extending portions 42b.

Moreover, as shown in FIG. 2 and FIG. 4, a waist portion 45 as a recess, which is depressed along the longitudinal direction of the terminal member 40 and in a direction in which the upper extending portion 41 and the lower extending portion 42 extend, is formed nearly in the center of the flat plate portion 40a.

The two terminal members 40, as shown in FIG. 2, are arranged outside the drum core 20 so as to be opposite to each other so that their inside curved surfaces 40b, each of which is a surface on a side from which the upper extending portion 41 and the lower extending portion 42 extend in the flat plate portion 40a, abut on the outer peripheral surfaces of the upper flange part 22 and the lower flange part 23, respectively. In a state where the inside surfaces 40b abut on the outer peripheral surfaces of the upper flange part 22 and the lower flange part 23, as shown in FIG. 3, the respective terminal members 40 have clearances 46 between portions where the cut portions 41d are formed in the perpendicular extending portions 41b and the upper flange part 22 and between portions where the cut portions 42d are formed in the perpendicular extending portions 42b and the lower flange part 23. Moreover, in this state, as shown in FIG. 2, the upper end surfaces 41e of the perpendicular extending portions 41b are at the same plane as the upper end surface 22a of the upper flange part 22 and the lower end surfaces 42e of the perpendicular extending portions 42b are also at the same plane as the lower end surface 23a of the lower flange part 23.

Moreover, the ends 30a of the winding 30 are arranged so as to be fit in the waist portions 45 in a state where the terminal members 40 are arranged outside the drum core 20 (refer to FIG. 1 and FIG. 4). Furthermore, the terminal members 40 are bonded and fixed to the drum core 20 by filling the clearances 46 and the like with an adhesive.

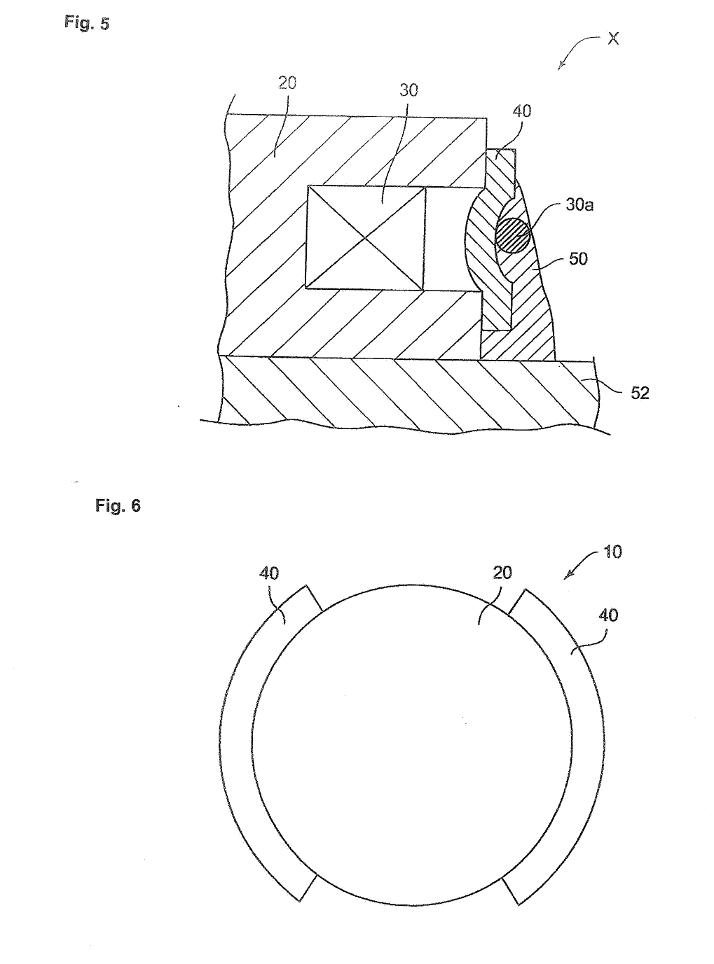

FIG. 5 is a partial cross-sectional view of a state where the inductor 10 is mounted on a substrate 52 and is an enlarged view showing a portion shown by X in FIG. 2.

The inductor 10, as shown in FIG. 5, is mounted on the substrate 52 so as to be electrically conductive by the use of solder 50 in a state where the end 30a of the winding 30 is arranged on the waist portion 45. However, the inductor 10 may be mounted on the substrate 52 by the other means without using the solder 50. Since the inductor 10 uses the terminal members 40 arranged on its side surface, as compared with a case where terminal members are arranged on the bottom surface of the inductor 10, the inductor 10 can be reduced in height by the thickness of the terminal member. Moreover, since the inductor 10 does not have any terminal member arranged on its bottom surface, the inductor 10 can be fixed to the substrate 52 more tightly by the solder 50.

Moreover, since the respective terminal members 40 have electrical conductivity and the ends 30a of the winding 30 are connected to the respective terminal members 40, the winding 30 can be electrically conductive to the substrate 52 in a state where the inductor 10 is mounted on the substrate 52.

Furthermore, the inductor 10 has the upper extending portions 41 and the lower extending portions 42 which extend from both ends of each of the terminal members 40. Hence, the clearances 46 are formed between the upper extending portions 41 and the upper flange part 22 and between the lower extending portions 42 and the lower flange part 23. Then, the respective terminal members 40 can be easily bonded and fixed to the drum core 20. Moreover, since the respective terminal members 40 are made of metal, the respective terminal members 40 are electrically conductive. For this reason, the winding 30 can be electrically conductive to the substrate 52 reliably in a state where the inductor 10 is mounted on the substrate 52.

Still further, in the inductor 10, the upper end surfaces 41e of the perpendicular extending portions 41b are at the same plane as the upper end surface 22a of the upper flange part 22 and the lower end surfaces 42e of the perpendicular extending portions 42a are also at the same plane as the lower end surface 23a of the lower flange part 23. For this reason, the respective terminal members 40 do not protrude in the up and down direction from the upper end surface 22a and the lower end surface 23a of the drum core 20. Thus, this can prevent the inductor 10 from being increased in height by the thickness of the terminal member 40.

Still further, since the waist portions 45 are formed in the respective terminal members 40, the ends 30a of the winding 30 can be arranged in the waist portions 45 so as to be fit therein. Hence, the inductor 10 can be easily mounted on the substrate 52 by the solder 50.

Moreover, since the ends 30a of the winding 30 are respectively arranged in the waist portions 45, the ends 30a are respectively put into reliable contact with the terminal members 40. Therefore, this can prevent the bad electrical contact between the winding 30 and the substrate 52 in a state where the inductor 10 is mounted on the substrate 52.

Up to this point, one embodiment of the present invention has been described. However, the present invention is not limited to the above-mentioned embodiment and the present invention can be put into practice in various modifications.

While the upper extending portions 41 and the lower extending portions 42 are formed in the respective terminal members 40 in the above-mentioned embodiment, the upper extending portions 41 and the lower extending portions 42 may be not formed. In this case, as shown in FIG. 6, when each of the terminal members 40 is bent in the shape of a circular arc so as to extend along the outside shapes of the upper flange part 22 and the lower flange part 23, the contact areas of the upper flange part 22 and the lower flange part 23 and the terminal members 40 are increased and then, the respective terminal members 40 can be easily fixed to the drum core 20 by an adhesive or the like. Moreover, there maybe employed the following configuration: that is, the clearances 46 are not formed between the cut portions 41d of the perpendicular extending portions 41b and the upper flange part 22 and between the cut portions 42d of the perpendicular extending portions 42b and the lower flange part 23, and the perpendicular extending portions 41b are put into direct contact with the upper flange part 22 and the perpendicular extending portions 42b are put into direct contact with the lower flange part 23.

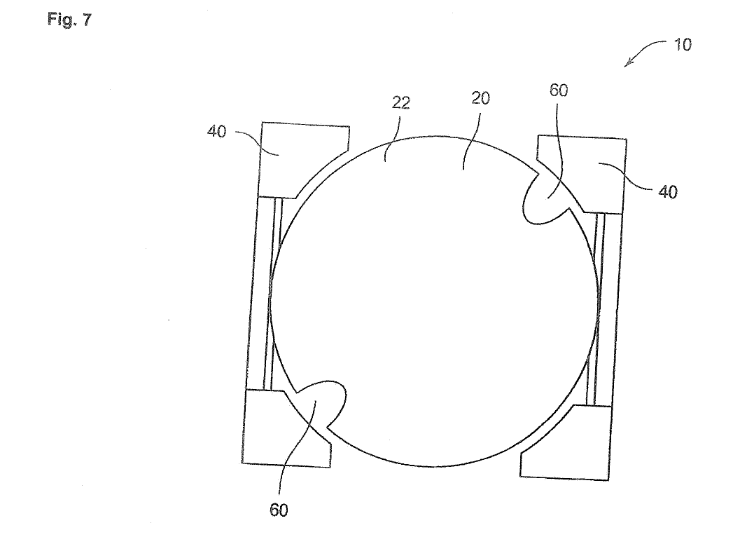

Moreover, in the above-mentioned embodiment, the waist portions 45 are formed in the respective terminal members 40. However, the present invention is not limited to this configuration and the waist portions 45 may not be formed in the respective terminal members 40. In this case, as shown in FIG. 7, when leading grooves 60 for leading the ends 30a of the winding 30 (not shown in FIG. 7) are formed in the upper flange part 22 of the drum core 20, the ends 30a can be easily led out from the drum core 20. Further, the leading grooves 60 may be formed in both of the upper flange part 22 and the lower flange part 23.

Further, in the above-mentioned embodiment, the plane shapes of the upper flange part 22 and the lower flange part 23 are circular. However, the plane shapes of the upper flange part 22 and the lower flange part 23 are not limited to being circular and may be polygonal such as square, rectangular, or ellipsoidal.

Still further, in the above-mentioned embodiment, the upper end surfaces 41e of the respective perpendicular extending portions 41b are formed at the same plane as the upper end surface 22a of the upper flange part 22, and the lower end surfaces 42e of the respective perpendicular extending portions 42b are formed also at the same plane as the lower end surface 23a of the lower flange part 23. However, the upper end surfaces 41e of the respective perpendicular extending portions 41b may be formed below the upper end surface 22a of the upper flange part 22, and the lower end surfaces 42e of the respective perpendicular extending portions 42b may be formed a little below the lower end surface 23a of the lower flange part 23.

Still further, in the above-mentioned embodiment, the drum-type core 20 is used as the core. However, the core is not limited to the drum-type core, and other kinds of cores such as a T core, an LP core, or a POT core may be used as the core.

Still further, a copper-based metal having a small electric resistance is used as the material of the terminal member 40 in the above-mentioned embodiment. However, the material of the terminal member 40 is not limited to this copper-based metal, and other kinds of metal such as copper or stainless may be used as the material of the terminal member 40. Moreover, a member having an electrically conductive film formed outside an electrically non-conductive member may be used as the terminal member 40.

Still further, while the drum-type core 20 is a nickel-based ferrite core, the material of the drum-type core 20 may be silicon steel, permalloy, dust core, or manganese-based ferrite core.

The inductor of the present invention can be used in various kinds of electronic devices such as mobile phone, personal computer, and television.

What is claimed is:

1. An inductor mounted on a substrate comprising:
a core,
a winding wound around the core,
wherein a terminal member having electrical conductivity is arranged on an outer peripheral portion of the core, and an end of the winding is connected to a position higher than a bottom surface of the core in the terminal member.

2. The inductor according to claim 1, wherein the terminal member is a metal member having extending portions which extend in the same direction from its both ends and formed in a shape of a letter C.

3. The inductor according to claim 2, wherein the terminal member has a recess formed on an outer peripheral surface formed in a shape of a letter C.

4. The inductor according to claim 1, wherein an upper end of the terminal member is located below an upper end surface of the core and wherein a lower end of the terminal member is located at the same plane of a lower end surface of the core or so as to slightly protrude downward from the lower end surface.

5. The inductor according to claim 2, wherein an upper end of the terminal member is located below an upper end surface of the core and wherein a lower end of the terminal member is located at the same plane of a lower end surface of the core or so as to slightly protrude downward from the lower end surface.

6. The inductor according to claim 3, wherein an upper end of the terminal member is located below an upper end surface of the core and wherein a lower end of the terminal member is located at the same plane of a lower end surface of the core or so as to slightly protrude downward from the lower end surface.

7. The inductor according to claim 1, wherein the terminal member is bonded and fixed to outer peripheral edges of flange parts formed on both ends of the core.

8. The inductor according to claim 2, wherein the terminal member is bonded and fixed to outer peripheral edges of flange parts formed on both ends of the core.

9. The inductor according to claim 3, wherein the terminal member is bonded and fixed to outer peripheral edges of flange parts formed on both ends of the core.

10. The inductor according to claim 7, wherein the outer peripheral edge of the flange part is formed in a shape of a circular arc, and wherein a surface of the terminal member bonded to the outer peripheral edge is formed in a shape of a circular arc so as to overlap the shape of a circular arc of the outer peripheral edge.

11. The inductor according to claim 8, wherein the outer peripheral edge of the flange part is formed in a shape of a circular arc, and wherein a surface of the terminal member bonded to the outer peripheral edge is formed in a shape of a circular arc so as to overlap the shape of a circular arc of the outer peripheral edge.

12. The inductor according to claim 9, wherein the outer peripheral edge of the flange part is formed in a shape of a circular arc, and wherein a surface of the terminal member bonded to the outer peripheral edge is formed in a shape of a circular arc so as to overlap the shape of a circular arc of the outer peripheral edge.

13. The inductor according to claim 1, wherein the core is a nickel-based ferrite core.

14. The inductor according to claim 2, wherein the core is a nickel-based ferrite core.

15. The inductor according to claim 3, wherein the core is a nickel-based ferrite core.
